(19) United States
(12) Patent Application Publication
(10) Pub. No.: US 2013/0030122 A1
(43) Pub. Date: Jan. 31, 2013

(54) ELASTOMERS CROSSLINKED BY POLYLACTIC ACID

(71) Applicants: Chaobin He, Singapore (SG); Ting Ting Lin, Singapore (SG); Pui Kwan Wong, Singapore (SG); Suming Ye, Singapore (SG)

(72) Inventors: Chaobin He, Singapore (SG); Ting Ting Lin, Singapore (SG); Pui Kwan Wong, Singapore (SG); Suming Ye, Singapore (SG)

(73) Assignee: Agency for Science, Technology and Research, Connexis (SG)

(21) Appl. No.: 13/640,936

(22) PCT Filed: Apr. 14, 2011
(86) PCT No.: PCT/SG2011/000147

§ 371 Date: Oct. 12, 2012

Related U.S. Application Data
(60) Provisional application No. 61/324,112, filed on Apr. 14, 2010.

(51) Int. Cl. C08G 63/91

(52) U.S. Cl. 525/69

(57) ABSTRACT

A composition is provided, which comprises chains comprising a first graft copolymer of a first elastomer and a poly(L-lactic acid), and chains comprising a second graft copolymer of a second elastomer and a poly(D-lactic acid). At least some of the poly(L-lactic acid) and poly(D-lactic acid) crosslink the chains. Poly(L-lactic acid) and poly(D-lactic acid) may form stereocomplexes that crosslink the chains. The chains may be crosslinked by crystalline structures formed from at least some of the poly(L-lactic acid) and poly(D-lactic acid) in discrete regions. The crosslinked chains may form a matrix. In a method of forming the composition, the first and second graft copolymers are mixed, such as by melt blending or solution casting, to form the composition. The graft copolymers may be formed by a “grafting-though” or “grafting-from” process. The composition may be useful under a relatively wide range of temperatures.

### CROSS-REFERENCE TO RELATED APPLICATION

This application claims the benefit of, and priority from, U.S. provisional application No. 61/324,112, filed Apr. 14, 2010; the entire contents of which are incorporated herein by reference.

### FIELD

The present invention relates generally to elastomeric compositions, and particularly to elastomeric polymers crosslinked by polylactic acid, and methods of forming such elastomeric polymers.

### BACKGROUND

Elastomers are useful materials and have a wide range of application in different fields. For example, styrene-butadiene-styrene tri-block copolymers have been used as elastomers and are commercially available. In such elastomers, dispersed polystyrene domains physically crosslink flexible polymeric chains, and thus they are easier to reprocess and recycle, as compared to chemically crosslinked or vulcanized rubbers.

### SUMMARY

It has been realized that the operating temperature range of many elastomers with both a continuous rubbery phase and a dispersed hard phase is limited by the softening temperature of the hard phase and by the glass transition temperature (T_{g}) of the rubbery phase. Thus, it is desirable to provide an elastomer with both a relatively high softening temperature of the hard phase, such as higher than about 100° C., and a relatively low T_{g} of the rubbery phase, such as lower than about −50° C.

It has been found that a polymeric matrix formed of an elastomeric polymer of a low T₉ and crosslinked with stereocomplexes of polylatic acid can have both a relatively high Tₘ, such as above about 200 or 230° C., and a relatively low T_{g}, such as below about −30° C.

Accordingly, in an aspect of the present invention, there is provided a composition. The composition comprises chains comprising a first graft copolymer of a first elastomer and poly(L-lactic acid), and chains comprising a second graft copolymer of a second elastomer and poly(D-lactic acid). The chains are crosslinked by crystalline structures formed from at least some of the poly(L-lactic acid) and poly(D-lactic acid) in discrete regions in the composition.

In exemplary embodiments, the crosslinked chains may form a matrix. The crystalline structures may be stereocomplexes of poly(L-lactic acid) and poly(D-lactic acid). The elastormers may form a first, continuous phase and the crystalline structures may form a second, dispersed phase. A weight ratio of the poly(L-lactic acid) to the poly(D-lactic acid) in the composition may be about 1:1. At least one of the first and second elastomers may comprise polyacrylate, such as poly(alkyl acrylate). The poly(alkyl acrylate) may comprise n-butyl acrylate, n-hexyl acrylate, or n-octyl acrylate. The poly(L-lactic acid) may be grafted to the first elastomer through a first hydroxy- or amine-functionalized acrylate group. The poly(D-lactic acid) may be grafted to the second elastomer through a second hydroxy- or amine-functionalized acrylate group.

In another aspect, the present invention provides a method of forming the composition described in the preceding paragraph. The method comprises mixing the first and second graft copolymers to form the composition, such as by melt blending the first and second graft copolymers, or by dissolving the first and second graft copolymers in a solution.

In selected embodiments, the method may comprise copolymerizing a monomer of the first elastomer and acrylate-terminated poly(L-lactic acid) to form the first graft copolymer, and copolymerizing a monomer of the second elastomer and acrylate-terminated poly(D-lactic acid) to form the second graft copolymer. Each of the first and second graft copolymers may be separately copolymerized in the presence of benzoyl peroxide at a temperature of about 75° C. in dioxane. Acrylate-terminated polylactic acid may be formed by reacting a lactide with a hydroxy-functionalized acrylate or an amine-functionalized acrylate with lactide. The method may also comprise copolymerizing a monomer of the first elastomer and a monomer of the second elastomer to form a copolymer precursor; and reacting a lactic acid with the copolymer precursor to graft an acrylate-terminated polylactic acid from a side chain of the copolymer precursor to form the first or second graft copolymer.

Other aspects, features, and embodiments of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention:

FIG. 1 is a schematic diagram of the structure of a composition, exemplary of an embodiment of the present invention;

FIG. 2 is a schematic diagram of a synthesis route for forming the composition of FIG. 1, exemplary of an embodiment of the present invention;

FIG. 3 is a line diagram showing X-ray diffraction (XRD) spectra of different sample materials and calculated spectra;

FIG. 4 is a line diagram showing temperature dependence of measured storage modulus of sample materials;

FIG. 5 is a schematic diagram of an alternative synthesis route for forming an intermediate compound shown in FIG. 2; and

FIG. 6 is a line graph showing the results of Dynamic Mechanical Analysis (DMA) of sample materials.

### DETAILED DESCRIPTION

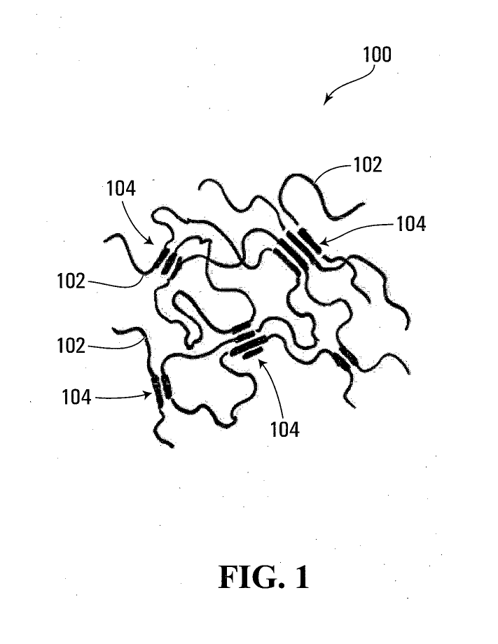

FIG. 1 schematically illustrates a composition 100, exemplary of an embodiment of the present invention. Composition 100 includes a continuous elastomer domain (phase) 102 and dispersed hard domains (phase) 104. As depicted in FIG. 1, composition 100 includes crosslinked polymer chains. The polymer chains include elastomeric segments, such as soft poly(alkyl acrylate) segments, and polylactic acid (PLA) segments. The PLA segments include both poly(L-lactic acid) (PLLA) and polyp-lactic acid) (PDLA). At least some of the PLLA and PDLA crosslink the polymer chains. The chains may be crosslinked by stereocomplexes formed from PLLA and PDLA (PLA stereocomplexes).

In exemplary embodiments, the continuous domain 102 of composition 100 is formed from elastomeric segments, such as soft poly(alkyl acrylate) segments, and the dispersed domains 104 are formed of PLA stereocomplexes. A domain 104 may include an aggregation of PLA stereocomplexes. PLA stereocomplexes are formed by co-crystallization of PLLA and PDLA. The chains are thus crosslinked by crystalline structures formed from at least some of the poly(L-lactic acid) and poly(D-lactic acid) in discrete regions in the composition. As illustrated in FIG. 1, the discrete regions are in domains 104.

In an embodiment, the continuous elastomer phase 102 may be formed of a poly(alkyl acrylate) with a T_{g} below the intended operating temperatures, such that the continuous phase will be rubbery at the normal operating temperatures. For example, for many applications, T_{g} should be below room temperature. For applications in cold environments, T_{g} should be even lower. A poly(alkyl acrylate) with a lower T_{g} may be used in a wider range of applications. For example, the T_{g} of poly(n-butyl acrylate) is about −49° C. and may be used in a wide range of applications. Suitable poly(alkyl acrylate) may be formed from an acrylate monomer such as n-butyl acrylate, n-hexyl acrylate, or n-octyl acrylate, or a combination thereof.

In selected embodiments, other suitable elastomers may also be used in composition 100. Elastomers with pendant hydroxy groups may be conveniently used to form PLA graft polymers. For example, in an embodiment, poly(isoprene) (PI) may be used as an elastomeric backbone in composition 100. In different embodiments, polybutadiene or ethylene propylene diene monomer (M-class) (EPDM) rubber may be used. The double bonds in these elastomers can be functionalized, such as by hydrogenation, to saturated hydrocarbon blocks, which can be conveniently utilized to compatiblizing PLA with, e.g. polyolefins.

As can be understood, the specific elastomers to be used in a particular embodiment may be selected based on various factors of interest in the particular application, and can be determined by those skilled in the art based on known properties of different elastomeric materials, such as elasticity, mechanical strength, reactivity, solubility, chemical resistance to certain materials, compatibility with other polymers, or the like.

The polymer chains in composition 100 include graft copolymer chains. A graft copolymer chain may contain one or more grafted PLLA or PDLA. In one embodiment, the ratio of PLLA and PDLA graft segments is 1. The number of PLA graft segments per graft copolymer chain may be greater than 1, such as from 2 to 10. In some embodiments, each graft copolymer chain may contain only PDLA or PLLA segments. When individual graft copolymer chains each contain only one type of PLLA segments, inter-chain stereocomplex formation may be maximized. When a graft copolymer chain contains both PDLA and PLLA, PLA stereocomplexes may be formed from PDLA and PLLA of the same chain (intra-chain stereocomplex formation). At least some of the PLLA and PDLA in different graft copolymer chains form stereocomplexes, which crosslink the different chains to form a polymeric matrix. In some embodiments, all or substantially all of the PLA enantiomers in composition 100 form stereocomplexes.

It should be understood that a PLA stereocomplex is different from a mere mixture of PLLA and PDLA in which no PLA stereocomplex is formed, in the sense that a PLA stereocomplex is a racemic configuration of PLLA and PDLA which exhibits properties that are significantly different from an optically pure PLA configuration. For example, the melting point temperature of a PLA material can be substantially increased due to formation of PLA stereocomplexes, as compared to the melting point temperature of an PLA material containing an optically pure PLA configuration, or a mere mixture of PLLA and PDLA with no PLA stereocomplex. Thus, the formation of PLA stereocomplex in a PLA-containing material can be detected by measuring certain properties, such as melting point temperature, heat of fusion, and crystal structure (e.g. as characterized by resonance frequencies measured by a suitable spectroscopic technique) of the PLA-containing material. As can be understood, melting point temperatures may be measured by differential scanning calorimetry (DSC), heat of fusion may be measured by Dynamic Mechanical Analysis (DMA), and crystal structures may be characterized by X-ray spectroscopy. Other suitable techniques may also be used to measure or characterize the crystal structure in a material, as can be understood by those skilled in the art.

In a melted state or in a solution, PLA stereocomplexes can aggregate or self-assemble and can form domains of crystalline lattices.

In composition 100, the elastomers in the copolymer chains form a soft phase, which is normally more elastic. The PLA stereocomplexes in composition 100 form a hard phase of dispersed domains, which is normally less elastic. A normal condition refers to the normal operating condition in a given application. Thus, composition 100 is a multi-phase substance.

As composition 100 contains elastomeric chain segments crosslinked by domains of PLA stereocomplexes, instead of linked by covalent bonds, a material or product formed from composition 100 can be conveniently reformed, reprocessed, or recycled.

Depending on the particular elastomer(s) in the graft copolymers, composition 100 may have a wide service temperature range, varying between the softening temperature of the PLA stereocomplex crosslinks at one end and T_{g} of the elastic phase at the other end.

In a specific embodiment, the elastomers in the copolymer chains may be poly(n-butyl acrylate) (PBA) formed from n-butyl acrylate monomers, and the weight ratio of PLLA and PDLA in composition 100 may be about 1:1. In such an embodiment, composition 100 has a relatively high use temperature, as compared to polystyrene-crosslinked thermoplastic elastomers. The latter is not suitable for use at temperatures above 100° C. due to softening of polystyrene. In this embodiment, composition 100 is polar, and thus exhibits better adhesion to polar substrates, as compared to non-polar thermoplastic elastomers such as styrene-butadiene elastomers.

In a further exemplary embodiment of the present invention, composition 100 may be formed by blending (i) graft copolymer of a selected poly(alkyl acrylate) and poly(L-lactic acid) (PAA-g-PLLA), and (ii) graft copolymer of a selected poly(alkyl acrylate) and poly(D-lactic acid) (PAA-g-PDLA).

The graft copolymers of PAA-g-PLLA and PAA-PDLA (also collectively or individually referred to as PAA-g-PLA) may be separately prepared to ensure that the individual copolymers each contains only PLLA or PDLA. A respective PAA-g-PLA may be formed by polymerizing an alkyl acrylate with a corresponding acrylate-terminated (capped) PLA. For example the alkyl acrylate and the corresponding acrylate-terminated (capped) PLA may be dissolved in a solution that contains a suitable solvent, e.g. dioxane, and a suitable polymerization initiator, e.g. benzoyl peroxide.

The acrylate-terminated PLAs may be formed by reacting a hydroxy- or amine-functionalized acrylate with L-lactide or D-lactide, respectively. Hydroxy- or amine-functionalized acrylate suitable for use as a ring opening polymerization initiator may be used. Suitable hydroxy-functionalized acrylates may include hydroxyethyl acrylate, such as 2-hydroxyethyl acrylate (HEA), or 2-hydroxyethyl methacrylate. In different embodiments, another suitable initiator may be used.

The initiator and the corresponding lactide or polylactide may be dissolved in a suitable organic solvent, such as anhydrous toluene or tetrahydrofuran. Various suitable Lewis acid metal complexes may be used as catalysts for the ring opening polymerization of lactide. For example, tin(II) octoate (also referred to as stannous octoate) and aluminum isopropoxide may be used. In an exemplary embodiment, the solution may contain about 1 wt % of stannous octoate based on the total weight of the lactide and the intiator. The solution may be heated to a suitable temperature, such as about 70° C., and continuously stirred. After the acrylate-terminated PLA is formed, the solvent and other components may be removed, such as by evaporation. The residue may be purified and dried according to standard procedures known to those skilled in the art.

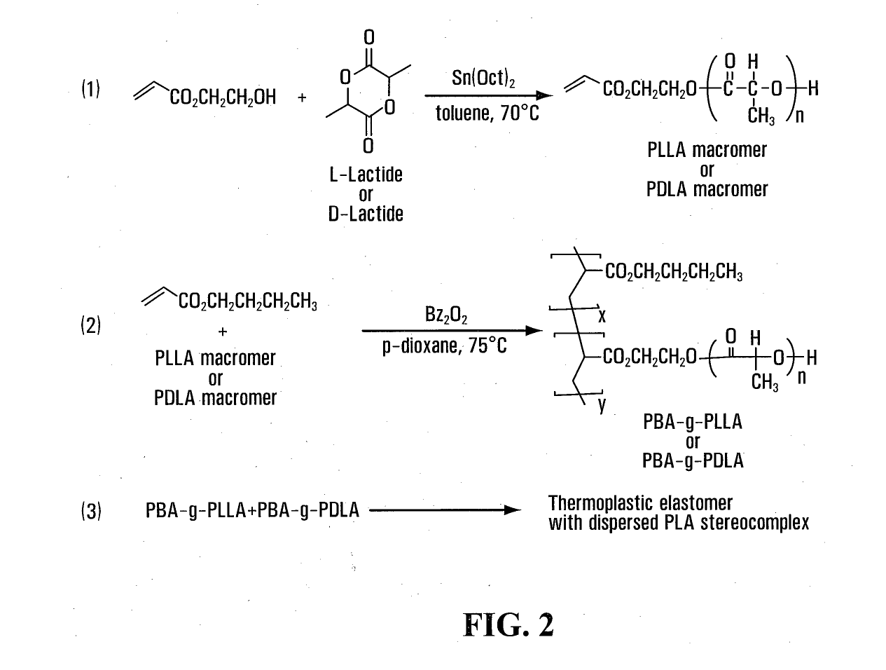

A specific exemplary synthesis route is illustrated in FIG. 2 and discussed in the Examples. As will be understood, in this route, the graft copolymer is formed in a “grafting-through” process. In FIG. 2, the values of “n”, “x” and “y” may vary depending on the weight percentages, molecular weights, or ratios of the various ingredients added in the reaction process including monomers, PLA macromers, and initiators. For example, the value of “n” may be controlled by adjusting the ratio of initiator and lactide in the reaction mixture. The amount of the PLA macromer in the resulting copolymer may vary from about 10 to about 50 wt %, such as from about 20 to about 30 wt %. The molecular weight of the PLA macromer may vary from about 2,000 to about 10,000 g/mol, such as from about 5,000 to about 20,000 g/mol.

The molecular weight (such as number or weight average molecular weight) of any intermediate or product may be measured using any suitable technique. For example, the molecular weight may be determined using high pressure liquid chromatography (HPLC), gel permeation chromatography (GPC), viscometry, vapor pressure osmometry or beam scattering techniques, among others.

In selected embodiments, graft copolymers, such as PBA-g-PLLA and PBA-g-PDLA, may be prepared using a “grafting-from” polymerization technique. Briefly, copolymer precursors may be formed by copolymerizing monomers of the first and second elastomers. A PLLA or PDLA can then be grafted from a side chain of a copolymer precursor. In particular, L-lactic acid may be reacted with the copolymer precursor to graft a side chain including an acrylate-terminated PLLA from the copolymer precursor, thus forming a PLLA graft copolymer. D-lactic acid may be reacted with the copolymer precursor to graft a side chain including an acrylate-terminated PDLA from the copolymer precursor, thus forming a PDLA graft copolymer.

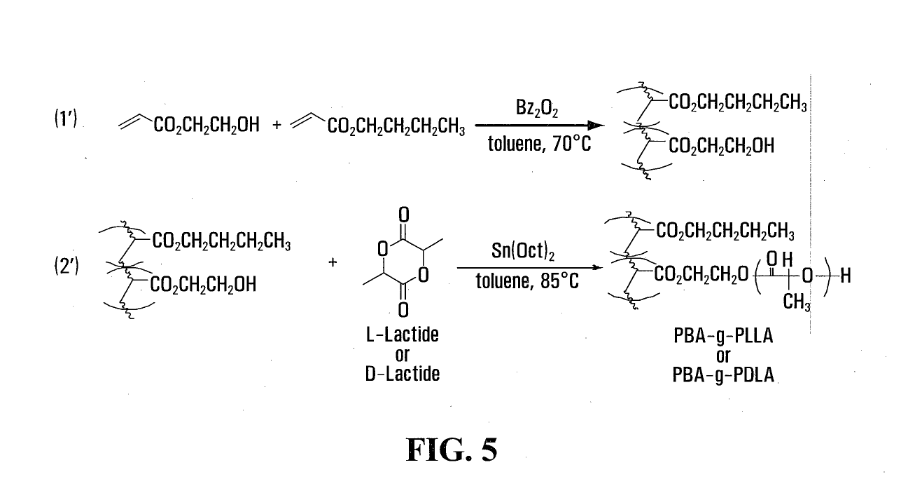

An exemplary “grafting-from” synthesis route is illustrated in FIG. 5 for grafting poly(n-butyl acrylate)-b-poly(2-hydroxyethyl acrylate) (PBA-b-PHEA) with PLA. With reference to route (1′) in FIG. 5, the copolymer precursor PBA-b-PHEA may be prepared by free radical polymerization using benzoyl peroxide (Bz₂O₂) as the initiator. As illustrated in route (2′) of FIG. 5, PBA-b-PHEA may be grafted with PLA by a “grafting-from” process using hydroxylated precursors of the n-butyl acrylate polymer as a macroinitiator of the ring-opening polymerization of lactide.

A difference between the “grafting-from” technique and “grafting-through” using a PLA macromer is that with the “grafting-from” technique as illustrated in FIG. 5, more densely grafted copolymers may be obtained.

PLA stereocomplexes may be formed by blending PLA enantiomers, or the PLLA and PDLA graft copolymers, by solution casting, or by melt blending. Both solution casting and melt blending technologies are well known to those skilled the art and can be readily adapted for application in the exemplary embodiments herein.

For example, melt blending may be conducted for example at 180° C. for about 10 minutes. The melt blend may be a 50:50 blend. That is the PLLA and PDLA graft copolymers in the blend has a 1:1 weight ratio. The melt blend may be dried and compression molded at, for example, about 200° C. Conveniently, the resulting dried blend may have a melting temperature as high as about 220° C. and a transition glass temperature of about −26° C.

The exemplary embodiments disclosed herein may be conveniently used in many applications of different fields. For example, exemplary compositions disclosed herein may have application in elastomers, rubber replacements, adhesives, or rubber tougheners.

Conveniently, at least some of the exemplary elastomer compositions are adhesive to polar materials.

In selected exemplary embodiments, elastomeric polymers may be formed of an alkyl acrylate monomer, and the resulting copolymer may have a T_{g} lower than 0° C. A polar copolymer of alkyl acrylates may exhibit good adhesion to polar materials.

It will be understood that when references are made to polymers formed of a specific monomer, such as L-lactic acid or D-lactic acid, the polymers are not necessarily entirely formed of the specified monomer. For example, a PLLA may not be formed of 100% LLA monomer units and a PDLA may not be formed of 100% DLA monomer units. In practice, a 100% pure polymer form is difficult to obtain, and the polymers may contain other components such as other monomers and defects. For example, a PLLA polymer may contain a small percentage of DLA or PDLA, and a PDLA polymer may contain a small percentage of LLA or PLLA. Depending on the particular application, in some embodiments, the purity of the polymer, including the optical purity of the polymer, may be from about 90% to about 100%. In some embodiments, the purity of the polymer may be from about 95% to about 100%. In some embodiments, the purity of the polymer may be from about 85% to about 100%. In some embodiments, the optical purity of the polymer may be above 66%, or above 72%. In some embodiments, the mole fraction of the minor enantiomer in the polymer may be less than 0.14, or less than 0.17. As can be understood, the optical purity of the polymer should be sufficiently high and its content of impurities including the minor enantiomer should be sufficiently low to allow PLA stereocomplexes to form.

Exemplary embodiments of the present invention are further illustrated with the following examples, which are not intended to be limiting.

### EXAMPLES

Lactide mentioned in these examples was purchased from Purac Biomaterials™, and used as received. The synthesis route for preparing the intermediate and final sample materials is as shown in FIG. 2.

The number average molecular weight (Mn) for all values listed below is given in units of g/mol.

### Example I

### Synthesis of PLLA Macromers

Sample PLLA macromers were prepared following the synthesis route (1) shown in FIG. 2. For each sample, a selected amount of L-lactide and stannous octoate (1 wt % of the total weight of lactide and the initiator) were dissolved in 150 ml anhydrous toluene in a Schlenk flask under an argon atmosphere. A selected amount of 2-hydroxyethyl acrylate was added to the solution as the ring-opening initiator. The amounts of the initiator and the catalyst were adjusted to form different samples with different molecular weights. The resulting mixture was heated to 70° C. and stirred for 3 days. Toluene was then removed under reduced pressure using a rotary evaporator. The residue was purified by dissolution in CH₂Cl₂ and precipitation from the solution by addition of methanol. The precipitate was dried under vacuum at 55-60° C. for 24 hours.

For one of the samples, referred to as Sample I, 21.6 g (150 mmol) of L-lactide, 0.221 g of stannous octoate, and 513.3 mg (4.42 mmol) of 2-hydroxyethyl acrylate were used to produce about 21.3 g of PLLA macromer, with GPC Mn=8094 and Mw=9967.

Two other samples, referred to as Sample IA and Sample IB, were formed with 14.4 g L-lactide and different amounts of initiator and catalyst. For Sample IA, molecular weights were found to be Mn=14319 and Mw=15356; and for Sample IB, Mn=28468 and Mw=32023.

### Example II

### Synthesis of PDLA Macromers

The procedure shown in route (1) of FIG. 2 and as described in Example I was followed but the L-lactide was replaced with D-lactide to produce PDLA macromer samples.

For Sample II, 21.6 g (150 mmol) of D-lactide, 0.221 g of stannous octoate, and 513.3 mg (4.42 mmol) of 2-hydroxyethyl acrylate were used to produce about 21.3 g of PDLA macromer, with GPC Mₙ=8308 and M_{w}=9976.

For Samples IIA and IIB, 14.4 g of D-lactide was used and the amounts of the initiator and catalyst were adjusted to produce sample macromers with different molecular weights. Sample IIA: Mn=13400 and Mw=14316. Sample IIB: Mn=28424 and Mw=31943.

### Example III

### Synthesis of Graft Copolymer PBA-g-PLLA

PBA-g-PLLA samples were prepared following the synthesis route (2) shown in FIG. 2. 9 g of n-Butyl acrylate (n-BA), 3 g of PLLA of Sample I, and 120 mg (1 wt %) of benzoyl peroxide were dissolved in 25 ml dioxane in a 100 ml Schlenk flask. The resulting solution was bubbled with argon for about 30 min to remove air and then heated to 70° C. with stirring overnight. The hot solution was poured into methanol to precipitate the graft copolymer. The precipitate yielded 10.7 g of graft copolymer PBA-g-PLLA (Sample III), with GPC Mₙ=67208 and M_{w}=239745.

Samples IIIA and IIIB were also prepared following the above procedure, but with Samples IA and IB as the respective PLLA macromer. Sample IIIA: Mn=61182 and Mw=167207. Sample IIIB: Mn=100348 and Mw=287192.

Sample IIIC was prepared as follows. 5 g of n-Butyl acrylate (n-BA), 3.3 g of PLLA of Sample IB, and 83 mg (1 wt %) of benzoyl peroxide were dissolved in 15 ml dioxane in a 100 ml Schlenk flask. The resulting solution was bubbled with argon for about 30 min to remove air and then heated to 75° C. with stirring overnight. The hot solution was poured into methanol to precipitate the graft copolymer. The precipitate yielded 6.8 g of graft copolymer PBA-g-PLLA (Sample IIIC), with GPC Mₙ=98637 and M_{w}=277134.

### Example IV

### Synthesis of Graft Copolymer PBA-g-PDLA

PBA-g-PDLA samples were prepared according to the synthesis route (2) of FIG. 2. 9 g of n-Butyl acrylate, 3 g of PDLA of Sample II, and 120 mg (1 wt %) of benzoyl peroxide were dissolved in 20 ml dioxane in a 100 ml Schlenk flask. The resulting solution was bubbled with argon for about 30 min to remove air and then heated to 70° C. with stirring overnight. The hot solution was poured into methanol to precipitate the graft copolymer. The precipitate yielded 10.6 g of graft copolymer PBA-g-PDLA (Sample IV), with GPC Mₙ=68747 and M_{w}=274797.

Sample IVA and IVB were also prepared following the above procedure. However, the macromers used were Sample IIA or IIB, respectively, instead of Sample II. Sample IVA: Mn=72731 and Mw=240989. Sample IVB: Mn=92390 and Mw=303983.

Sample IVC was prepared as follows. 5 g of n-Butyl acrylate (n-BA), 3.3 g of PDLA of Sample IIB, and 83 mg (1 wt %) of benzoyl peroxide were dissolved in 15 ml dioxane in a 100 ml Schlenk flask. The resulting solution was bubbled with argon for about 30 min to remove air and then heated to 75° C. with stirring overnight. The hot solution was poured into methanol to precipitate the graft copolymer. The precipitate yielded 7.0 g of graft copolymer PBA-g-PDLA (Sample IVC), with GPC Mₙ=93511 and M_{w}=271863.

### Example V

### Film of PBA-g-PLLA

Different samples of PBA-g-PLLA prepared in Example III were dispersed in methylene chloride (Tedia™, 99.5%) to form precursor solutions with a polymer concentration of 0.1 g/ml (i.e. 1.6 g of each polymer dissolved in 16 ml methylene chloride). The solutions were cast onto a glass Petri dish. The cast solutions were allowed to evaporate at room temperature and then dried at 40° C. in a vacuum oven for one week to form sample films of PBA-g-PLLA. Samples VA, VB, and VC (also collectively referred to as Samples V) were formed from Samples IIIA, IIIB and IIIC, respectively.

### Example VI

### Film of PBA-g-PDLA

Sample films of PBA-g-PDLA were prepared following the procedure of Example V but replacing PBA-g-PLLA samples with samples of PBA-g-PDLA prepared in Example IV. Film samples VIA, VIB, and VIC (also collectively referred to as Samples VI) were formed from Samples IVA, IVB, and IVC respectively.

### Example VII

### Film of Racemate of PBA-g-PLLA and PBA-g-PDLA

Elastomer samples were prepared according to the synthesis route (3) of FIG. 2. Samples of both PBA-g-PLLA and PBA-g-PDLA were dispersed in methylene chloride to form precursor solutions. 0.8 g PBA-g-PLLA was dissolved in 8 ml methylene chloride. 0.8 g PBA-g-PDLA was dissolved in 8 ml methylene chloride. For each sample, the two solutions were mixed to form a blend solution. In each blend solution, the concentrations of PBA-g-PLLA and PBA-g-PDLA samples were about the same (thus forming a racemic mixture in which the ratio of PBA-g-PLLA and PBA-g-PDLA was about 1:1). The blend solutions were cast onto a glass Petri dish. The cast solutions were allowed to evaporate at room temperature and then dried at 40° C. in a vacuum oven for about a week to form sample films of racemate of PBA-g-PLLA and PBA-g-PDLA: Samples VIIA, VIIB, and VIIC (also collectively referred to as Samples VII) were formed. Samples VIIA was a 50:50 physical blend film from Samples IIIA and IVA. Sample VIIB was a 50:50 physical blend film from Samples IIIB and IVB. Sample VIIC was a 50:50 physical blend film from Samples IIIC and IVC.

The concentrations of the ingredients in the precursor solutions for forming. Samples V, VI, VII are summarized in TABLE I.

TABLE I

| | Concentration of | Concentration of | |
|---|---|---|---|
| | PBA-g-PLLA | PBA-g-PDLA | Weight Ratio |
| Sample | (wt %) | (wt %) | (n-BA/PLA) |
| VA | 100 | 0 | 3/1 |
| VIA | 0 | 100 | 3/1 |
| VIIA | 50 | 50 | |
| VB | 100 | 0 | 3/1 |
| VIB | 0 | 100 | 3/1 |
| VIIB | 50 | 50 | |
| VC | 100 | 0 | 3/2 |
| VIC | 0 | 100 | 3/2 |
| VIIC | 50 | 50 | |

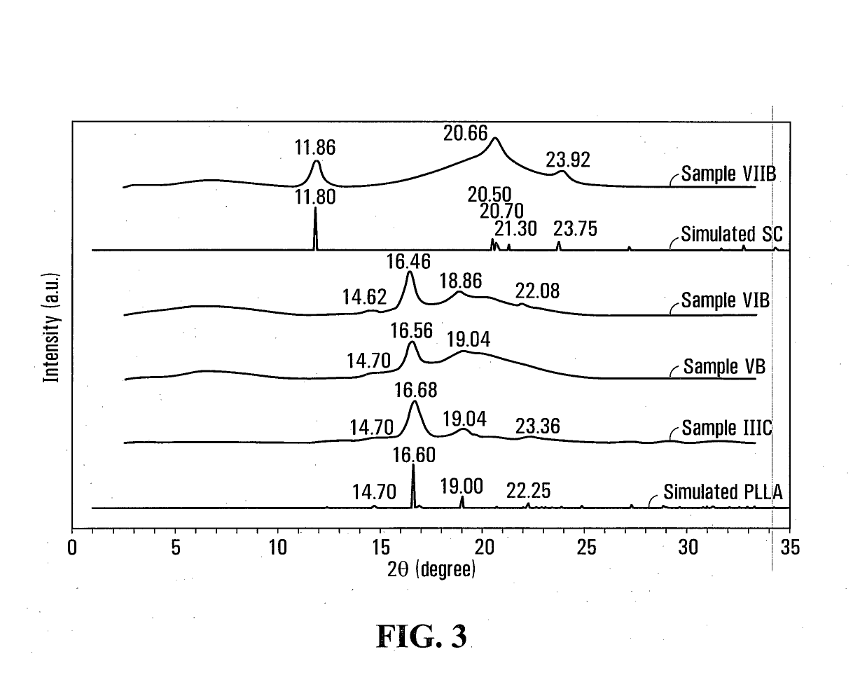

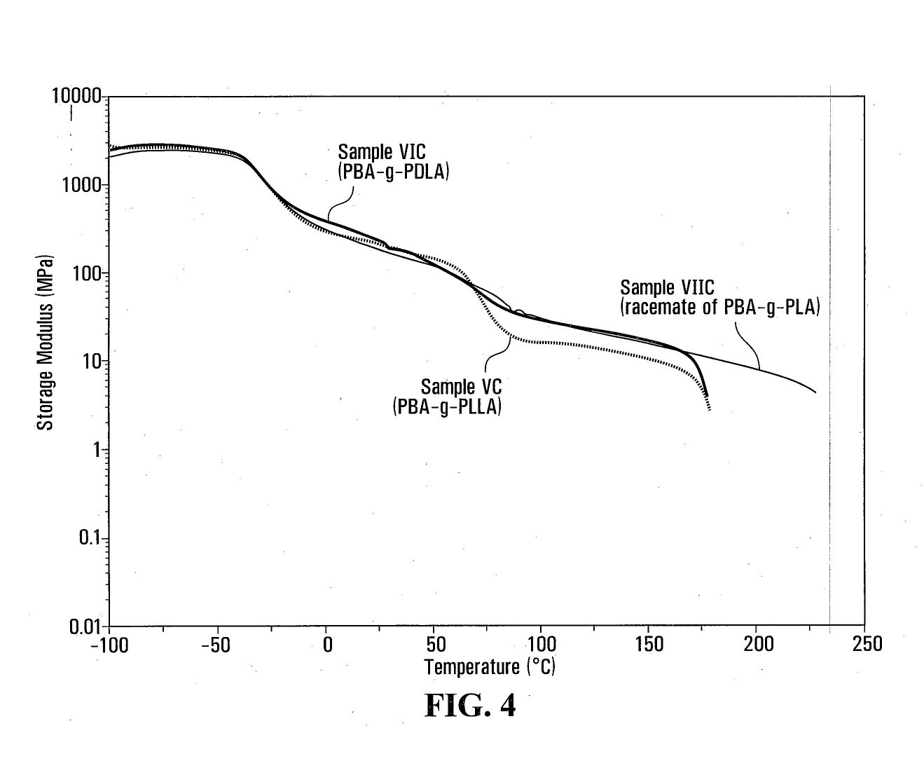

The properties of Samples V, VI, and VII were measured using DSC, XRD and DMA techniques. Representative DSC results are shown in Table II. Representative XRD and DMA results are shown in FIGS. 3 and 4, respectively.

TABLE II

| | Tₘ | ΔH | Mₙ of | Mₙ |
|---|---|---|---|---|
| Sample | (° C.) | (J/g) | PLA | (PBA-g-PLA) |
| VA | 156 | 13.9 | 14,319 | 61,182 |
| VIA | 154 | 11.3 | 13,400 | 72,731 |
| VIIA | 230 | 22.1 | — | — |
| VB | 166 | 11.6 | 28,468 | 100,348 |
| VIB | 166 | 9.8 | 28,424 | 92,390 |
| VIIB | 246 | 13.2 | — | — |
| VC | 167 | 27.5 | 28,468 | 98,637 |
| VIC | 167 | 24.6 | 28,424 | 93,511 |
| VIIC | 247 | 37.5 | — | — |

The results showed that Samples VII have much higher melting points (temperatures) and heat of fusion than Samples V and VI. The domains of PLA stereocomplexes in the Samples contained crystals. A higher heat of fusion indicates a higher crystallinity.

XRD results indicated that the Samples V, VI, and VII contain partially crystalline polymers, as each spectrum was a superposition of peaks (indicative of a crystalline phase) and a broad halo (indicative of an amorphous phase).

The measured data indicated that stereocomplexes of polylactic acid formed in Samples VII. For example, FIG. 3 shows both the spectra obtained from Samples VB, VIB, and VIIB and the theoretical spectra calculated based on simulation of single crystal of PLLA α-form or stereocomplex (sc) formed between PLLA-PDLA (with ratio of 1:1). It can be seen that the peak positions in measured spectrum of Sample VIIB closely match the peak positions in simulated spectrum of stereocomplex (sc), and the peak positions in the spectra of Samples VB and VIB closely match the peak positions in the simulated spectrum of PLLA α-form.

The measured data also indicated that Samples VII could maintain good mechanical strength at a higher temperature than Samples V and VI did. For example, as shown in FIG. 4, the storage modulus of Samples VC and VIC dropped sharply at about 180° C., but the storage modulus of Sample VIIC did not exhibit similar sharp decrease below about 230° C. Thus, it is expected that in some applications Sample VIIC is suitable for use at higher temperatures, as compared to Samples VC and VIC.

### Example VIII

### Synthesis of Graft Copolymers by Alternative Routes

Sample graft copolymers PBA-g-PLA were also prepared following the synthesis route shown in FIG. 5.

54 g (0.42 mol) n-BA, 0.58 g HEA (0.005 mol) (feed molar ratio of n-BA to HEA was 84) and 183 mg Bz₂O₂ were dissolved in 75 ml dry toluene and then degassed via three freeze-thaw cycles. The mixture was stirred at 70° C. overnight. The viscous mixture was then diluted with THF and poured into large excess of methanol. The solution stood still for a few hours and the upper layer was decanted. To remove methanol and moisture, the obtained PBA was dissolved in toluene and the solvent was removed on a rotovap. It was further dried in vacuum oven at 70° C. until no water peak was seen from nuclear magnetic resonance (NMR). 43.38 g of PBA, denoted as Sample VIII-1, was obtained, with Mn=90620 and Mw=194037.

In a 3-neck flask, 43.38 g of Sample VIII-1, 28.92 g L-lactide (feed weight ratio of n-BA to LLA is 1.5) were dissolved in 200 ml dry toluene and then 0.29 g Sn(Oct)₂ in 5 ml toluene was added via syringe. The mixture was stirred under Ar by a mechanical stirrer at 85° C. for 3 days. Toluene was then removed from the rotovap. The residue was purified by dissolution in CH₂Cl₂ and precipitation from the solution by addition of methanol. The precipitate was dried under vacuum at 55-60° C. for 24 hours. The resulting sample was denoted as Sample VIII-L.

Samples VIII-2 and VIII-D were also prepared, following the above procedures for forming Samples VIII-1 and VIII-L respectively, with the exception that, instead of L-lactide, D-lactide was used for forming Samples VIII-2 and VIII-D. For Sample VIII-2, Mn=92246 and Mw=274840.

Some test results of Samples VIII-L and VIII-D are shown in Table III, in which the values of the weight ratio of W_{pn-BA}W_{PLA} were obtained from NMR.

TABLE III
Composition and Molecular Weight of
Graft Copolymers VIII-L and VIII-D

| Sample | Mn | Mw | W_{pn-BA}/W_{PLA} |
|---|---|---|---|
| VIII-L | 111825 | 208087 | 1.63 |
| VIII-D | 143023 | 274840 | 1.47 |

### Example IX

### Stereocomplex Formation by Melt Blending

Sample compositions with stereocomplexes formed between enantiomeric PLA containing graft copolymers were prepared by melt blending from the samples formed in Example VIII as follows.

Samples VIII-L and VIII-D were blended in a 50:50 mixture at 180° C. for 10 min using a Barbender™ mixer.

Sample specimens for mechanical testing were prepared by compression molding the dried melt blends at 200° C. and 6000 lb for 5 minutes using a Carver™ press and a rectangular mold with dimensions of 100 mm (length)×100 mm (width)×1.2 mm (height).

The test results showed that stereocomplexes were formed between enantiomeric PLA side chains of sample graft copolymers by melt blending.

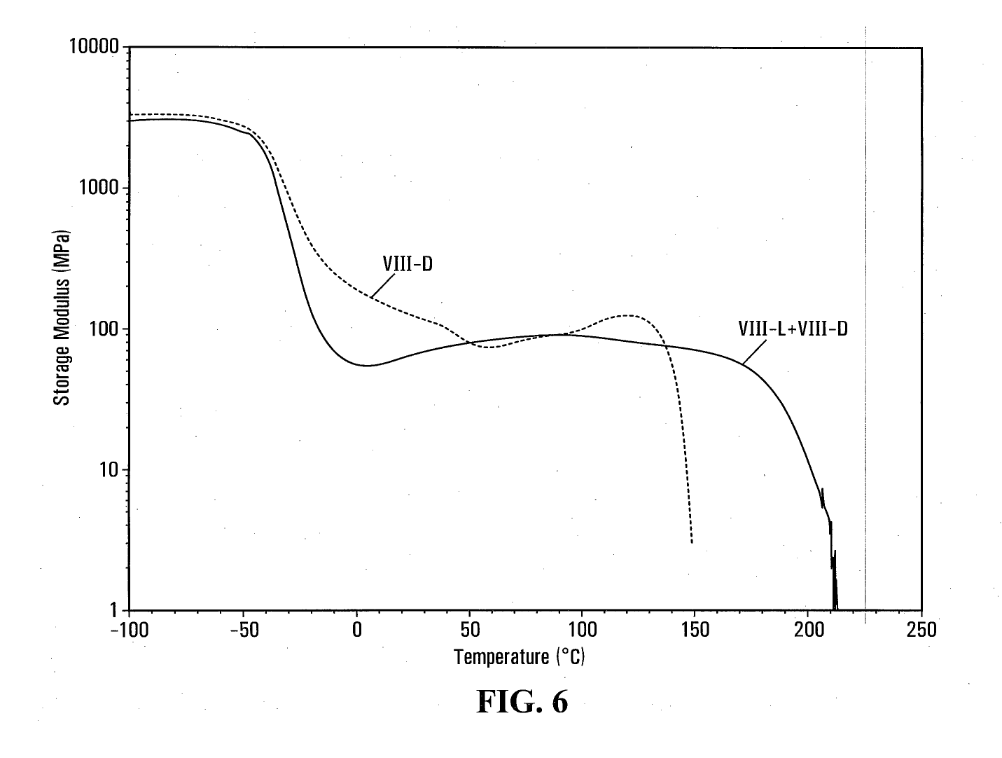

The results were confirmed by Differential scanning calorimetry (DSC) and Dynamic Mechanical Analysis (DMA). DSC results showed that the T_{g} of the sample blends was −26° C. and the Tₘ of the sample blends was at 224° C. FIG. 6 shows representative measured results of storage modulus for Sample VIII-D and sample blends of VIII-L and VIII-D as functions of temperature as measured by DMA, which indicated that the sample blends had sufficient mechanical strength for use at temperatures as high as about 220° C. The sample specimens tested in FIG. 6 had dimensions of 17.5 mm×8.62 mm×1.2 mm.

It will be understood that any range of values herein is intended to specifically include any intermediate value or sub-range within the given range, and all such intermediate values and sub-ranges are individually and specifically disclosed.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments are intended to be illustrative only and in no way limiting. The described embodiments are susceptible to many modifications of form, arrangement of parts, details and order of operation.

The invention, rather, is intended to encompass all such modification within its scope, as defined by the claims.

1. A composition, comprising:
chains comprising a first graft copolymer of a first elastomer and a poly(L-lactic acid); and
chains comprising a second graft copolymer of a second elastomer and a poly(D-lactic acid);
wherein said chains are crosslinked by crystalline structures formed from at least some of said poly(L-lactic acid) and said poly(D-lactic acid) in discrete regions in said composition.

2. The composition of claim 1, wherein said crosslinked chains form a matrix.

3. The composition of claim 1, wherein said crystalline structures are stereocomplexes of said poly(L-lactic acid) and poly(D-lactic acid).

4. The composition of claim 1, wherein said elastomers form a first, continuous phase and said crystalline structures form a second, dispersed phase.

5. The composition of claim 1, wherein a weight ratio of said poly(L-lactic acid) to said poly(D-lactic acid) in said composition is about 1:1.

6. The composition of claim 1, wherein at least one of said first and second elastomers comprises a polyacrylate.

7. The composition of claim 6, wherein said polyacrylate comprises a poly(alkyl acrylate).

8. The composition of claim 1, wherein said poly(L-lactic acid) is grafted to said first elastomer through a first hydroxy-functionalized acrylate group, and wherein said poly(D-lactic acid) is grafted to said second elastomer through a second hydroxy-functionalized acrylate group.

9. A method of forming the composition of claim 1, comprising mixing the first and second graft copolymers to form said composition.

10. The method of claim 9, wherein said mixing comprises melt blending said first and second graft copolymers, or dissolving said first and second graft copolymers in a solution.

11. The method of claim 9, comprising copolymerizing a monomer of the first elastomer and an acrylate-terminated poly(L-lactic acid) to form the first graft copolymer; and
copolymerizing a monomer of the second elastomer and an acrylate-terminated poly(D-lactic acid) to form the second graft copolymer.

12. The method of claim 11, wherein each of said first and second graft copolymers is separately copolymerized in the presence of benzoyl peroxide at a temperature of about 75° C. in dioxane.

13. The method of claim 11, comprising forming an acrylate-terminated polylactic acid by reacting a lactide with a hydroxy-functionalized acrylate.

14. The method of claim 9, comprising copolymerizing a monomer of the first elastomer and a monomer of the second elastomer to form a copolymer precursor; and
reacting a lactic acid with said copolymer precursor to graft an acrylate-terminated polylactic acid from a side chain of said copolymer precursor to form said first or second graft copolymer.
